(19) United States
(12) Patent Application Publication
(10) Pub. No.: US 2002/0133104 A1
(43) Pub. Date: Sep. 19, 2002

(54) Mounted self massage device and method of use

(76) Inventor: Douglas H. Bedgood, Key West, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/010,563

(22) Filed: Oct. 26, 2001

Related U.S. Application Data
(60) Provisional application No. 60/275,340, filed on Mar. 13, 2001.

(51) Int. Cl. A61H 7/00

(52) U.S. Cl. 601/134

(57) ABSTRACT

Self massage devices are provided. A representative self massage device includes a base, at least one massage member fixed to the base and extending therefrom, and a mounting member fixed to the base and extending therefrom opposing the massage member. Methods of effectuating self massage and other devices are also provided.

### CROSS-REFERENCE TO RELATED APPLICATION

This application claims priority to copending U.S. provisional application entitled, “Wall Mounted Self Massage Device,” having Ser. No. 60/275,340, filed Mar. 13, 2001, which is entirely incorporated herein by reference.

### BACKGROUND OF THE INVENTION

1. Field of the Invention

The present invention generally relates to massage devices and, in particular, to mounted devices for self massage and methods for use thereof.

2. Description of the Related Art

Massage involves tissue manipulation by rubbing, kneading or tapping a muscle or muscle groups with one's hand or with the use of a therapeutic device. There are various types of known tissue massage. Neuromuscular massage effects nerves and is generally achieved by pinpointing a single location on the body, such as with certain portions of the hand or with massage devices having a knob for massage contact points. Similarly, massage of superficial large areas, generally achieved by manipulation of large areas of superficial tissue, results in creating a general overall relaxation and can be achieved by manipulation with hands or with a device having spheroid roller and/or balls for massage contact points. Known self massage devices typically facilitate these types of general relaxation massages and require the user to engage their own muscles in the vicinity of the muscles being manipulated, therefore at least partially defeating the intended purpose. It is also known, however, that other types of massage are beneficial, such as deep skeletal muscle fasciculi endomysium, involving isolation of parallel portions of muscle tissue.

Receiving a massage typically requires the assistance of another person, such as that of a masseur. In such situations, it is the assistant who uses their hands or a therapeutic device to manipulate muscle tissue for the recipient. Not only does this approach to massage require the recipient to employ the assistance of another, but the strength with which and the amount of time for which a massage can be administered is limited by the strength and stamina of the individual performing the muscle manipulation.

Thus, a heretofore unaddressed need exists in the industry to address the aforementioned and/or other deficiencies and inadequacies.

### SUMMARY OF THE INVENTION

The present invention provides devices and methods for performing self massage.

Briefly described, one embodiment of such a system, among others, is a self massage device comprising a base having a top surface and a bottom surface, at least one massage member fixed to the top surface of the base and extending therefrom. The device further comprises a mounting member fixed to the bottom surface of the base and extends therefrom.

The present invention can also be viewed as providing methods for effectuating self massage. In this regard, one embodiment of such a method, among others, can be broadly summarized by the following steps: orienting a self massage device to accommodate muscles desired to be massaged; mounting the self massage device; leaning against the self massage device; applying pressure at a desired massage point; and moving against the self massage device to massage the muscles.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of an embodiment of the mounted self massage device of the present invention.

FIG. 2 is a perspective view of another embodiment of the mounted self massage device illustrated in FIG. 1.

FIG. 3 is a perspective view of another embodiment of the mounted self massage device illustrated in FIG. 1.

FIG. 4 is an illustration of a method of use of an embodiment of the mounted self massage device of the present invention.

FIG. 5A is a top planar view of an embodiment of the mounted self massage device of the present invention oriented in a first position.

FIG. 5B is a top planar view of an embodiment of the mounted self massage device of the present invention oriented in a second position.

FIG. 5C is a top planar view of an embodiment of the mounted self massage device of the present invention oriented in a third position FIG. 5D is a top planar view of an embodiment of the mounted self massage device of the present invention oriented in a fourth position.

### DETAILED DESCRIPTION

The present invention generally provides a device and method for administering self massage. As will be described in greater detail herein, an embodiment of the self massage device of the present invention is a device mountable on a variety of surfaces and adapted to provide members arranged and configured to with which one can perform self muscle manipulation.

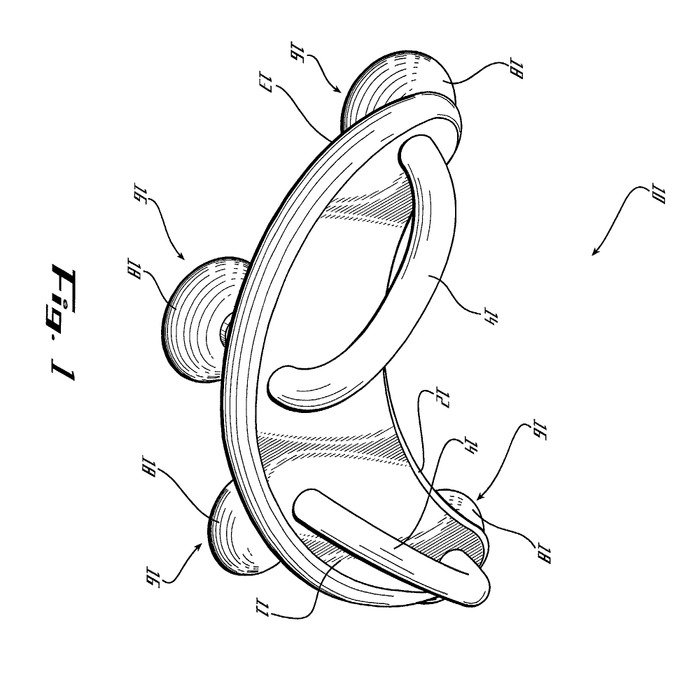

Reference will now be made to the drawings, wherein like numerals indicate corresponding parts throughout the several views. A first embodiment of the self massage device 10 is illustrated in FIG. 1. Overall, the self massage device 10 is of small size, lightweight, and is readily mountable and portable. The self massage device 10 comprises a base 12, at least one massage member 14 and at least one mounting member 16. As illustrated, the base 12 is substantially planar and kidney-shaped. The base 12 can, however, comprise any shape capable of supporting massage member 14 when in use. The base 12 can comprise a substantially rigid material such as plastic, hard rubber, etc. The self massage device 10 comprises at least one massage member 14, but preferably a pair of massage members 14 extending from base 12. Massage member 14 can be disposed toward on edge of the base 12 or toward an interior portion.

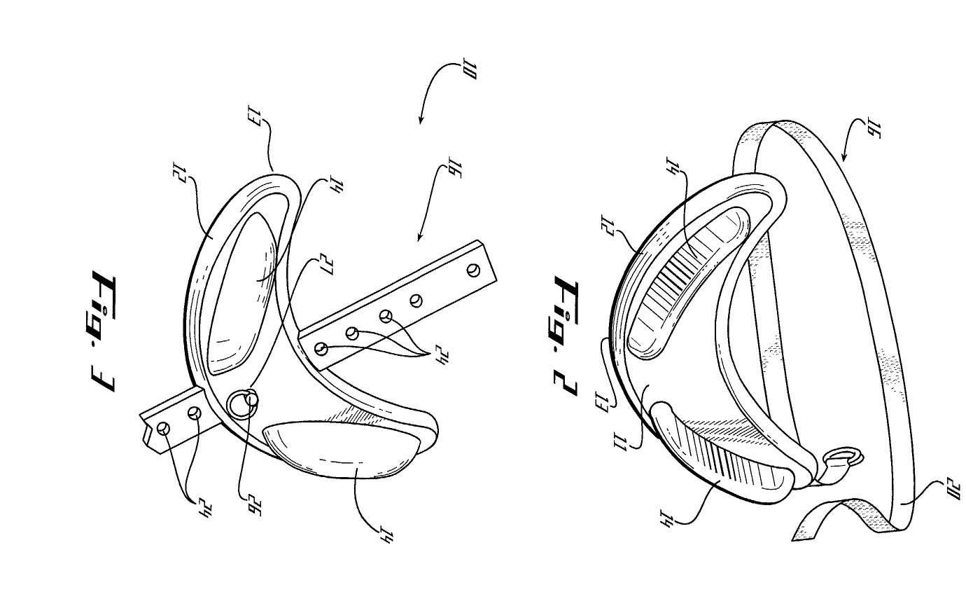

Each massage member 14 comprises a substantially ellipsoid arc with a relatively narrow width along the length of the top profile enabling the massage member 14 to capture deep myofibril length and isolate parallel portions of tissue with which the member 14 is engaged. This type of deep tissue muscle manipulation allows the user to effectively separate dysfunctional binding of fascia until myofibrils can lengthen and slide efficiently. As shown, the massage member 14 can be formed of a member having a circular cross-section (as illustrated in FIG. 1), resulting in a void space in the middle of the member 14, or as a substantially planar solid member (as illustrated in FIGS. 2 and 3). A massage member 14 having a substantially circular cross-section can also be used as a handle to carry the device 10 when it is not in use and as a handle to remove the device 10 from a mounted position. A substantially circular cross-sectional massage member 14 also adds less weight to the overall weight of the device 10, as compared to a solid massage member 14. In the alternative, massage member 14 can also comprise a substantially solid ellipsoid arc. As substantially elliptical arc configuration can comprise a substantially linear width from the member's 14 upper portion to the lower portion meeting the base 12, resulting in a substantially kidney-shaped cross-section at the intersection of massage member 14 and base 12. An elliptical arc configuration can also be substantially tapered from the upper portion of the massage member 14 to the lower portion meeting the base 12, resulting in a substantially elliptical cross-section at the intersection of massage member 14 and base 12. Although the edge of the substantially solid massage members 14 are illustrated as being at least slightly inset on the base 12 from the edge of the base 12, it should be understood that the edge of the massage member 14 can also be flush with the edge of the base 12 or extending therebeyond. The massage member 14 comprises a substantially rigid material, such as plastic, hard rubber, or the like. The massage members 14 are disposed on the top surface 11 of the base 12 in a substantially perpendicular manner with respect to the base 12 and oriented on the base 12 such that a longitudinal axis running through each of the massage members 14 are in a substantially V-shaped configuration to each other with a space therebetween at the apex of the “V.” It should be understood, however, that the massage members 14 can be arranged in a variety of configurations with respect to each other, such as substantially parallel, having a substantially acute angle therebetween, or any configuration capable of facilitating the desired massage. The massage members 14 can also be pivotally mounted to the base 12. In this configuration the massage members 14 can be disposed in various configurations without moving the base 12. A self massage device 10 comprising pivotally connected massage members 14 also provides capability for the massage members 14 to be arranged and configured in a greater range of configurations than massage member 14 fixedly mounted to the base 12.

The self massage device 10 comprises at least one mounting member 16. The mounting member 16 preferably facilitates quick and easy mounting and removal of the device 10. In one embodiment, the mounting member 16 can comprise at least one, but preferably a plurality of suction cups 18 (as illustrated in FIG. 1). The suction cups 18 facilitate mounting the self massage device 10 on a substantially planar, non-porous surface, including but not limited to, substantially vertical surfaces, substantially horizontal surfaces, and curved surfaces (such as, for example, the curved inner surface of a hot tub, or the like).

In another embodiment, the mounting member 16 can comprise a strap 20 (as shown in FIG. 2). The strap 20 is fixed to the bottom surface 13 of the base 12 and is arranged and configured to releasably engage the back of a chair, the person to be massaged, or the like. The strap 20 can preferably engage objects, such as a chair, of various sizes by employing a fastening member 22 such as a clasp 21, hook and loop fastening system (not shown), or by comprising a substantially elastic continuous member (not shown).

In another embodiment, shown in FIG. 3, the mounting member 16 comprises a track 22 having at least one, but preferably a plurality of track apertures 24 disposed therethrough and a pin 26. The track 22 comprises a surface mount 28 for mounting the track 22 to any surface capable of engaging the surface mount 28. FIG. 3 illustrates the surface mount 28 as a screw disposed through an aperture in the track 22. It should be noted, however, that the surface mount 28 can comprise any suitable mechanism. Where this configuration of the mounting member 16 is employed, the base 12 of the self massage device 10 includes a mounting aperture 27 disposed therethrough and being capable of receiving a fixing member, such as a pin 26. The pin 26 can be disposed through the mounting aperture 27 disposed though the base 12 of the device 10 and through a track aperture 24 on which the device 10 is to be mounted. In this configuration, the self massage device 10 can be adjusted to the appropriate position along the track 22 by removing the pin 26, placing the self massage device 10 in the desired location, aligning the mounting aperture 27 in the base 12 with the appropriate track aperture 24. The device 10 is fixed into position by engaging the pin 26 through both the mounting aperture 27 and the track aperture 24.

OPERATION

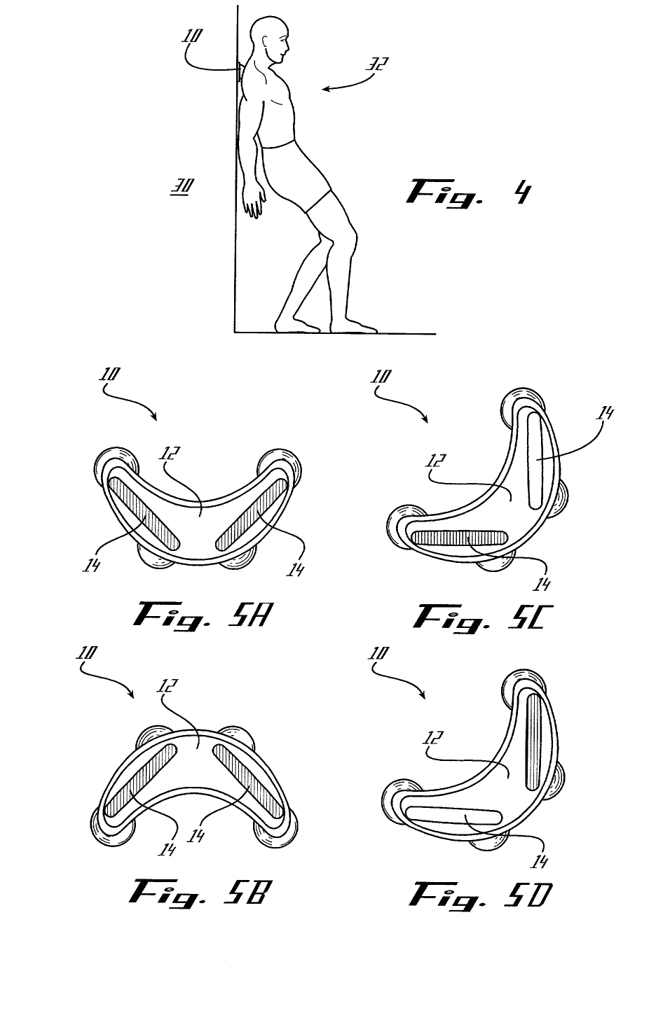

FIG. 4 provides a general illustration of the self massage device 10 in use. The self massage device 10 can be mounted on a mount surface 30 such as a wall, door, or the like, by the mounting member 16 such that the massage member 14 extends away from the mount surface 30. Prior to mounting the self massage device 10, the device 10 should be oriented in the appropriate manner, addressed in more detail below, and positioned at the appropriate height along the mount surface 30 in order to effectuate the type of massage on the muscle group(s) desired. After positioning the device 10, the recipient, or user, 32 leans against the massage members 14 of the self massage device 10 and moves along the massage members 14 in a steady controlled manner.

The mounting position for the self massage device 10 is a function of the muscle group(s) the user desires to massage. It is generally desirable that the self massage device 10 is oriented such that the apex of the V-shape orientation of the massage members 14 is pointing directly downward, directly upward, or rotated substantially 45 degrees to the side, thereby orienting the massage members 14 in an L-shape. As illustrated in FIG. 5A, the self massage device 10 is oriented in a first position such that the V-shape relationship of the longitudinal axis of the massage members 14 is arranged with the apex of the “V” pointing downward. In this first position, a user can engage both massage members 14 to effectuate cross-fiber massage techniques on at least the following muscle groups: splenius capitis; serratus posterior inferior; lower trapezius; lattissimus dorsi; rotator cuff infraspinatus; rotator cuff teres minor.

As illustrated in FIG. 5B, the self massage device 10 is oriented in a second position such that the apex of the V-shape relationship formed by the longitudinal axis of the massage members 14 is pointing upward. In this second position orientation, both massage members 14 of the self massage device 10 can be engaged by the user to massage at least the following muscle groups: quadratus lumborum; multifidus; iliocostalis cervicis; serratis posterior superios; upper trapezius; levator scapula; rhomboid major; rhomboid minor; posterior deltoid; gluteus maximus; gluteus medius; gluteus minimus.

As illustrated in FIG. 5C, the self massage device 10 is oriented in a third position such that one massage member 14 is substantially vertical and the opposing massage member 14 is arranged in a substantially horizontal position. In this third position orientation, the user can engage the substantially horizontal oriented massage member 14 to effectuate cross-fiber massage techniques on at least the following muscle groups: middle trapezius; periformis.

Similarly, and as illustrated in FIG. 5D, the self massage device 10 is oriented in a fourth position such that one massage member 14 is disposed in a substantially horizontal position and the opposing massage member 14 is oriented in a substantially vertical position. In this fourth position orientation, the user can engage the substantially vertically oriented massage member 14 to massage at least the following muscle groups: splenius cervicis; semispinalis capitis, cervicis, thoracis; longissimus capitis, cervicis, thoracis; iliocostalis thoracis, lumborum; lateral deltoid; rotator cuff supraspinatus; tensor fasciae latae.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A self massage device comprising:
a base having a top surface and a bottom surface, said base being substantially rigid and adapted to withstand pressure applied thereto;
a massage member having a substantially ellipsoid arc shape and being fixed to said top surface of said base and extending therefrom, said massage member being substantially rigid and adapted to withstand pressure applied thereagainst, said massage member being substantially narrow at an apex portion of said ellipsoid arc shape such as to engage and manipulate a muscle; and
a mounting member fixed to said bottom surface of said base and extending therefrom, said mounting member being adapted to support said base and said massage member while pressure is applied thereto.

2. The self massage device of claim 1, wherein said base is substantially kidney-shaped.

3. The self massage device of claim 1, wherein said base is substantially planar.

4. The self massage device of claim 1, wherein said base comprises a substantially rigid material.

5. The self massage device of claim 1, wherein said massage member comprises a substantially eliptical arc, said substantially arcuately shaped outer surface being at least a portion of said massage member.

6. The self massage device of claim 5, wherein said massage member is a substantially solid and planar member.

7. The self massage device of claim 5, wherein said massage member comprises a substantially circular cross-section.

8. The self massage device of claim 1, wherein said massage member further comprises:
a pair of massage members each having a longitudinal axis, said pair of massage members disposed on said top surface and extending away therefrom such that said longitudinal axis of said pair of massage member are arranged in a substantially V-shape configuration.

9. The self massage device of claim 1, wherein said massage member comprises a substantially rigid material.

10. The self massage device of claim 1, wherein said massage member is pivotally fixed to said base.

11. The self massage device of claim 1, wherein said mounting member comprises a suction cup.

12. The self massage device of claim 1, wherein said mounting member comprises a strap being sized adjustable and arranged and configured to releasably receive a portion of a chair.

13. The self massage device of claim 1, wherein said mounting member further comprises:
a mounting aperture disposed through said base of the device;
a track having a length and a track aperture disposed therethough along said length; and
a pin arranged and configured to engage said mounting aperture and said track aperture disposed through said track;
wherein said self massage device is mounted on said track when said mounting aperture and said track aperture is aligned and said pin is disposed therethrough.

14. The self massage device of claim 1, wherein said track comprises a plurality of track apertures disposed threrethrough.

15. A method of administering self massage comprising the steps of:
orienting a self massage device to accommodate muscles desired to be massaged;
mounting said self massage device;
leaning against said self massage device and applying pressure at a desired massage point; and
moving against said self massage device to massage muscles as desired.

16. The method of claim 15, wherein said step of mounting said self massage device comprises mounting said device on a substantially planar surface in a substantially vertical position.

17. The method of claim 15, wherein said step of mounting said self massage device comprises mounting said device on a chair in a substantially vertical position.

18. A self massage device comprising:
a massage means for manipulating muscle tissue, said massage means being substantially rigid;
a support means for supporting said massage means, said support means being substantially rigid;
a mounting means for mounting said self massage device in a substantially stationary manner, said mounting means being fixed to said support means.

19. A self massage device comprising:
a base having a top surface and a bottom surface;
a pair of massage members fixed to said top surface of said base and extending therefrom, said massage member comprising a member having a substantially circular cross-section and formed in a substantially elliptical arch, wherein said massage members form a V-shape having a space therebetween at an apex of the V-shape;
a plurality of suction cups disposed on said bottom surface of said base and extending therefrom, wherein said suction cups are arranged and configured to mount the self massage device on a substantially planar, non-porous surface.
